(19) United States
(12) Patent Application Publication
(10) Pub. No.: US 2011/0090427 A1
(43) Pub. Date: Apr. 21, 2011

(54) LIGHT GUIDE PLATE, BACKLIGHT DEVICE AND LIQUID CRYSTAL DISPLAY DEVICE

(75) Inventors: Makoto Ohue, Osaka-shi (JP); Koji Yamabuchi, Osaka-shi (JP); Yuji Yashiro, Osaka-shi (JP); Hiroaki Shigeta, Osaka-shi (JP)

(73) Assignee: SHARP KABUSHIKI KAISHA, Osaka-shi, Osaka (JP)

(21) Appl. No.: 12/994,228

(22) PCT Filed: Mar. 13, 2009
(86) PCT No.: PCT/JP2009/054840

§ 371 Date: Nov. 23, 2010

(30) Foreign Application Priority Data
May 28, 2008 (JP) 2008-139150

(51) Int. Cl. G02F 1/1335; F21V 7/04

(52) U.S. Cl. 349/65; 362/626

(57) ABSTRACT

Provided is a light guide plate which can suppress glare with reduced thickness. Specifically, a light guide plate (1) is provided with a light incoming surface (1a), a light outgoing surface (1b) and a light reflecting surface (1c). A diffraction grating pattern (11) is formed on the light outgoing surface (1b), and a prism pattern (12) is formed on the light reflecting surface (1c). On a region of the light reflecting surface (1c) on the side of the light incoming surface (1a), the prism pattern (12) does not exist, and the region where the prism pattern (12) is formed is smaller than the region where the diffraction grating pattern (11) is formed.

### TECHNICAL FIELD

This invention relates to a light guide plate, a backlight device, and a liquid crystal display device.

### BACKGROUND ART

There is conventionally known, as a display device, a liquid crystal display device that displays images by use of a liquid crystal display panel (formed of a pair of substrates sandwiching a liquid crystal layer therebetween). The liquid crystal display device is characterized by having a reduced thickness and a lower power consumption compared with other types of display devices and has been adopted widely as a display device mounted in office automation equipment such as a personal computer, portable information terminal equipment such as an electronic notepad and a mobile telephone, a camcorder, and the like.

Furthermore, the above-described liquid crystal display device has a backlight device for illuminating the liquid crystal display panel and is so configured that the liquid crystal display panel is illuminated by the backlight device, and thus an image is displayed. The backlight device for illuminating the liquid crystal display panel includes a light source formed of a light-emitting diode element (LED) or a fluorescent tube, a light guide plate that guides light generated by the light source and outputs it toward the side of the liquid crystal display panel, and the like. In addition, in order to obtain an increased luminance in a direction toward the liquid crystal display panel and to prevent the variation in luminance depending on a visual angle from becoming sharp, multiple optical sheets (such as a diffusion sheet and a prism sheet) are disposed on a light output surface of the light guide plate (see, for example, Patent Document 1).

Meanwhile, in recent years, there has been a demand for further thickness reduction of a backlight device for the achievement of thickness reduction of a liquid crystal display device. Even so, if the optical sheets are omitted from the above-described configuration of the backlight device for the achievement of thickness reduction, there arises a disadvantage that luminance characteristics and visual angle characteristics are deteriorated.

As a solution to this, conventionally, there has been proposed a technique in which a diffraction grating pattern, a prism pattern, and the like are formed integrally on a predetermined surface of a light guide plate so as to allow the light guide plate itself to have a function of improving luminance characteristics and visual angle characteristics (see, for example, Patent Documents 2 to 4).

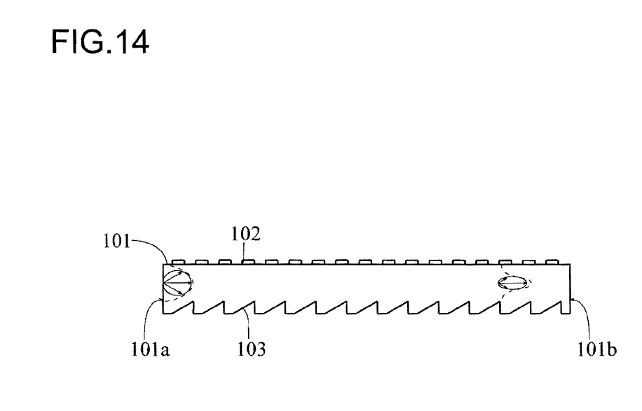

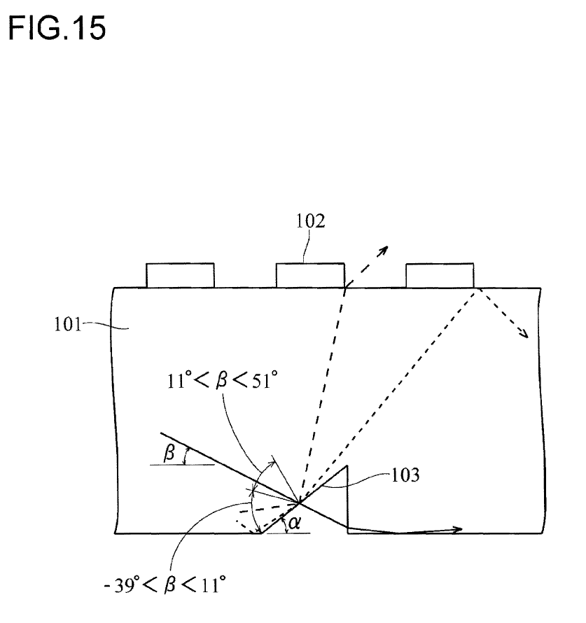

As shown in FIGS. 14 and 15, Patent Document 2 discloses a configuration in which a diffraction grating pattern 102 is provided over the entire area of a light output surface (front surface) of a light guide plate 101, and a prism pattern 103 is provided over the entire area of a light reflection surface (back surface) of the light guide plate 101, with a prism angle (an angle a in FIG. 15) of the prism pattern 103 set to about 40°.

Furthermore, Patent Document 3 discloses a configuration in which a hologram pattern is provided over the entire area of a light output surface (front surface) of a light guide plate, and a prism pattern is provided over the entire area of a light reflection surface (back surface) of the light guide plate.

Furthermore, Patent Document 4 discloses a configuration in which a diffraction grating pattern is provided over the entire area of a light output surface (front surface) of a light guide plate, and a light reflection surface (back surface) of the light guide plate is inclined so that the light guide plate has a thickness decreasing gradually with increasing distance from a light incidence surface (predetermined side end surface) of the light guide plate.
Patent Document 1: JP-A-2006-133274
Patent Document 2: JP-A-2007-178829
Patent Document 3: JP-A-2004-111383
Patent Document 4: JP-A-2001-155520

### DISCLOSURE OF THE INVENTION

### Problems to be Solved by the Invention

In the configuration of Patent Document 2, as shown in FIG. 15, when light traveling at a β angle (angle formed between the light and the light reflection surface (back surface) of the light guide plate 101) of 11° is incident on the prism pattern 103, the light is reflected off an inclined surface of the prism pattern 103 and then travels nearly in a direction of the normal to the light output surface of the light guide plate 101. Furthermore, when light traveling at an angle smaller than 11° as the β angle is incident on the prism pattern 103, the light is reflected totally off an inclined surface of the prism pattern 103 and then travels in a diagonally right direction. Furthermore, when light traveling at an angle larger than 11° as the β angle is incident on the prism pattern 103, the light passes through an inclined surface of the prism pattern 103 to be refracted and then is refracted again at a surface opposed to the inclined surface of the prism pattern 103. That is, the angle at which light travels is made to vary by the prism pattern 103, so that light distribution characteristics vary.

Here, in the configuration of Patent Document 2, since the prism pattern 103 is provided over the entire area of the light reflection surface (back surface) of the light guide plate 101 as shown in FIG. 14, light becomes incident on the prism pattern 103 multiple times repeatedly, thus causing light distribution characteristics to vary at a rate increasing in a direction from the side of a light incidence surface 101a (predetermined side end surface) to the side of a counter-light incidence surface (surface of the light guide plate 101 on the side opposite to the light incidence surface 101a) 101b of the light guide plate 101. That is, the incidence angle of light incident on the diffraction grating pattern 102 varies largely between in a region of the light guide plate 101 on the side of the light incidence surface 101a and in a region of the light guide plate 101 on the side of the counter-light incidence surface 101b, so that the output angle of light outputted from the diffraction grating pattern 102 varies largely between in the region of the light guide plate 101 on the side of the light incidence surface 101a and in the region of the light guide plate 101 on the side of the counter-light incidence surface 101b. Because of this, the uniformity of output light over the entire surface cannot be achieved, resulting in causing the occurrence of glare.

Also in the configuration of Patent Document 3, since the prism pattern is provided over the entire area of the light reflection surface (back surface) of the light guide plate, there arises a problem similar to that in the above-described case of the configuration of Patent Document 1.

In the configuration of Patent Document 4, although a prism pattern is not provided on the light reflection surface (back surface) of the light guide plate, since the light reflection surface (back surface) of the light guide plate is inclined, there arises a problem similar to that in the above-described case of the configuration of Patent Document 1. Incidentally, the inclined light reflection surface (back surface) of the light guide plate leads to a disadvantage that the thickness of the light guide plate can hardly be reduced. Moreover, in a case where a reflection sheet is disposed on the light reflection surface (back surface) of the light guide plate, the reflection sheet should be placed so as to lie along the inclined light reflection surface (back surface) of the light guide plate, leading to another disadvantage that a support portion of a frame for supporting the reflection sheet should be inclined at the same angle as the inclination angle of the light reflection surface (back surface) of the light guide plate. Because of these reasons, the configuration of Patent Document 4 is not preferable from the viewpoint of reducing the thickness of a backlight device.

In order to solve the above-described problems, it is an object of this invention to provide a light guide plate, a backlight device, and a liquid crystal display device that are capable of suppressing the occurrence of glare while achieving thickness reduction.

### Means for Solving the Problem

In order to achieve the above-described object, a light guide plate according to a first aspect of this invention includes: a light incidence surface for introducing light therethrough; a light output surface for outputting, in a planar shape, light introduced through the light incidence surface; and a light reflection surface, which is a surface on the side opposite to the light output surface, for reflecting light introduced through the light incidence surface toward the side of the light output surface. Furthermore, a diffraction grating pattern is formed on the light output surface, and a prism pattern is formed on the light reflection surface. The prism pattern is not present in a region of the light reflection surface on the side of the light incidence surface, so that a region in which the prism pattern is formed is smaller than a region in which the diffraction grating pattern is formed.

In the light guide plate according to the first aspect, with the above-described configuration, light reflection and refraction by the prism pattern do not occur in a region of the light guide plate on the side of the light incidence surface, and light reflection by the prism pattern occurs only in a region of the light guide plate other than the region on the side of the light incidence surface. In this case, by forming the prism pattern under an appropriate condition (such a condition as to maximally prevent light inside the light guide plate from having an incidence angle exceeding a critical angle), in the region of the light guide plate other than the region on the side of the light incidence surface, the angle at which light travels (angle formed between the light and a direction perpendicular to the light incidence surface of the light guide plate) increases in steepness gradually in a direction from the side of the light incidence surface to the side of a counter-light incidence surface (surface of the light guide plate on the side opposite to the light incidence surface) of the light guide plate. This allows substantially the same light distribution characteristics to be obtained in the region of the light guide plate on the side of the light incidence surface and in a region of the light guide plate on the side of the counter-light incidence surface. Thus, the incidence angle of light incident on the diffraction grating pattern is made substantially the same between in the region of the light guide plate on the side of the light incidence surface and in the region of the light guide plate on the side of the counter-light incidence surface, so that the output angle of light outputted from the diffraction grating pattern is made substantially the same between in the region of the light guide plate on the side of the light incidence surface and in the region of the light guide plate on the side of the counter-light incidence surface. As a result, the uniformity of output light over the entire surface can be achieved, thereby allowing the occurrence of glare to be suppressed. Furthermore, in the light guide plate according to the first aspect, light is outputted efficiently from the diffraction grating pattern, thereby also allowing improved light utilization efficiency to be obtained. Moreover, when the light guide plate according to the first aspect is used in a backlight device, there is no need to dispose optical sheets on the light output surface of the light guide plate, and thus the thickness reduction of the device can be easily achieved.

In the above-described light guide plate according to the first aspect, preferably, the prism pattern is made up of groove portions extending in a direction parallel to the light incidence surface and is formed so as to have a surface inclined at an angle of not less than 0.5° and not more than 20° relative to the light reflection surface. According to this configuration, in the region of the light guide plate other than the region on the side of the light incidence surface, the angle at which light travels (angle formed between the light and the direction perpendicular to the light incidence surface of the light guide plate) can be easily increased in steepness gradually in the direction from the side of the light incidence surface to the side of the counter-light incidence surface (surface of the light guide plate on the side opposite to the light incidence surface) of the light guide plate.

In the above-described light guide plate according to the first aspect, preferably, the diffraction grating pattern is formed so as to have a grating pitch of not less than 360 nm and not more than 470 nm and a grating height of not less than 160 nm and not more than 240 nm According to this configuration, high diffraction efficiency can be obtained with respect to light of a plurality of different wavelengths.

A backlight device according to a second aspect of this invention includes: the above-described light guide plate according the first aspect; and a light source for generating light to be introduced to the light guide plate. According to this configuration, a backlight device can be easily obtained that has a reduced thickness and is unlikely to cause the occurrence of glare.

A liquid crystal display device according to a third aspect of this invention includes: the above-described backlight device according to the second aspect; and a liquid crystal display panel that is illuminated by the backlight device. According to this configuration, a liquid crystal display device can be easily obtained that has a reduced thickness and is unlikely to cause the occurrence of glare.

### ADVANTAGES OF THE INVENTION

As described above, according to the present invention, a light guide plate, a backlight device, and a liquid crystal display device can be easily obtained that are capable of suppressing the occurrence of glare while achieving thickness reduction.

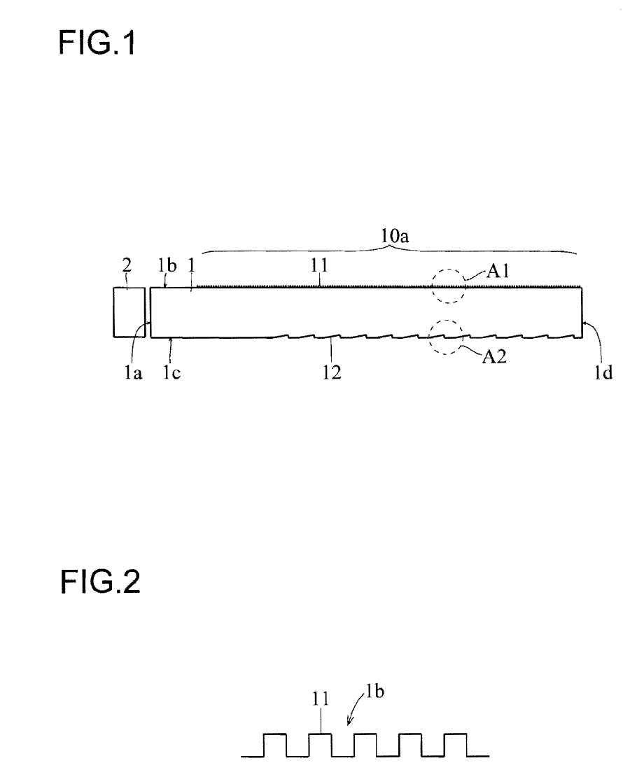

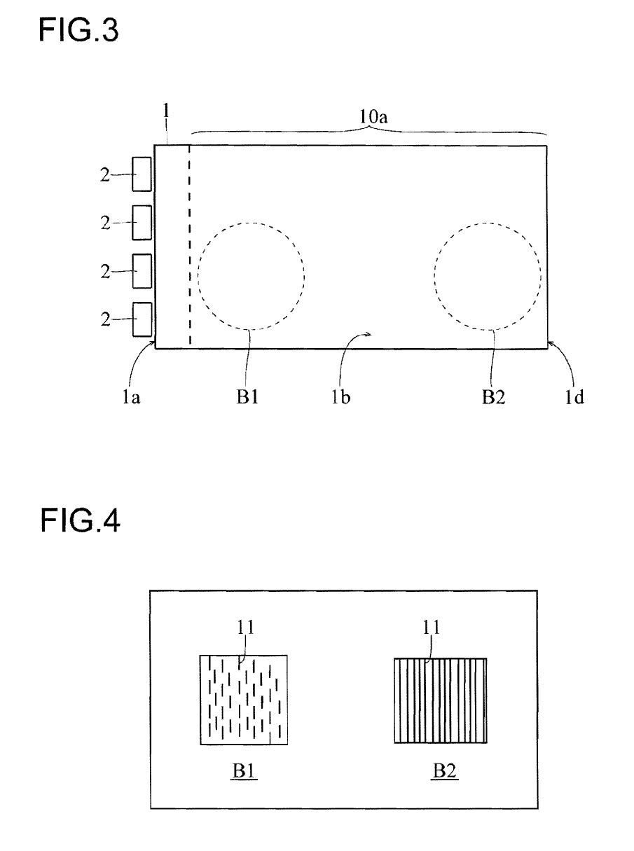

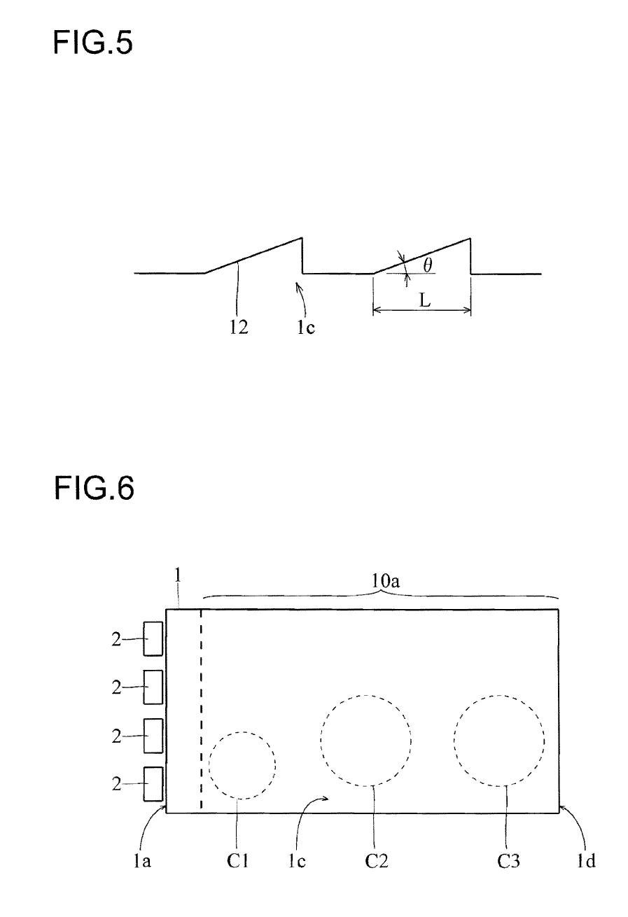

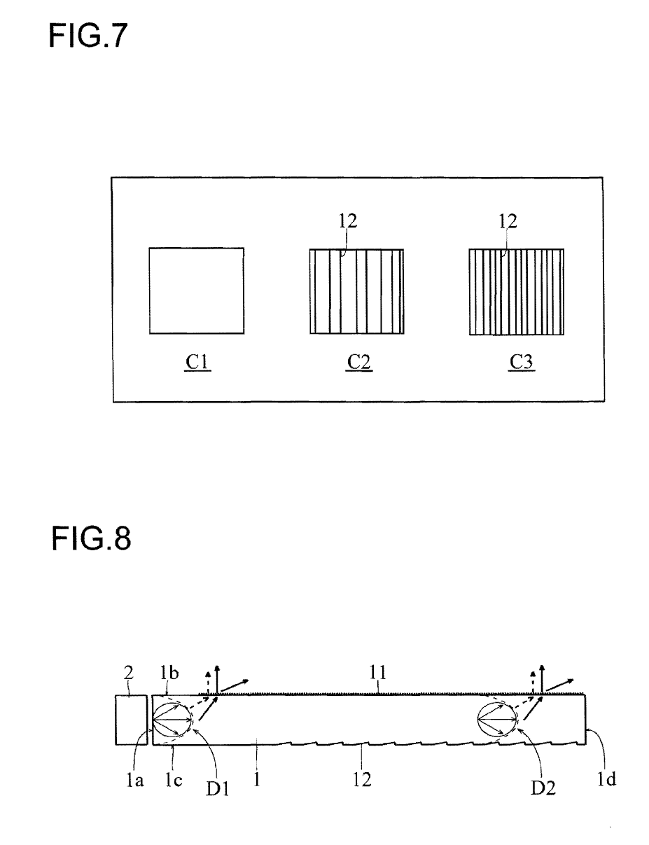

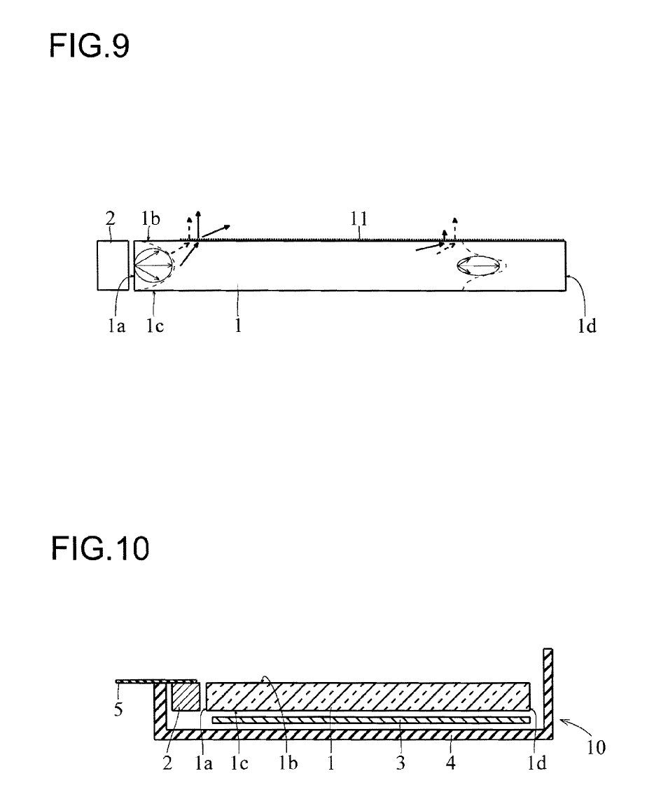

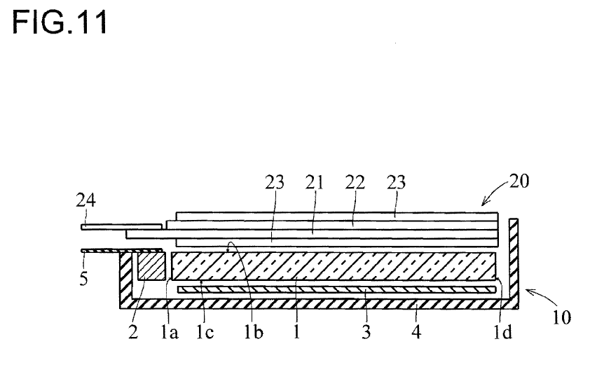

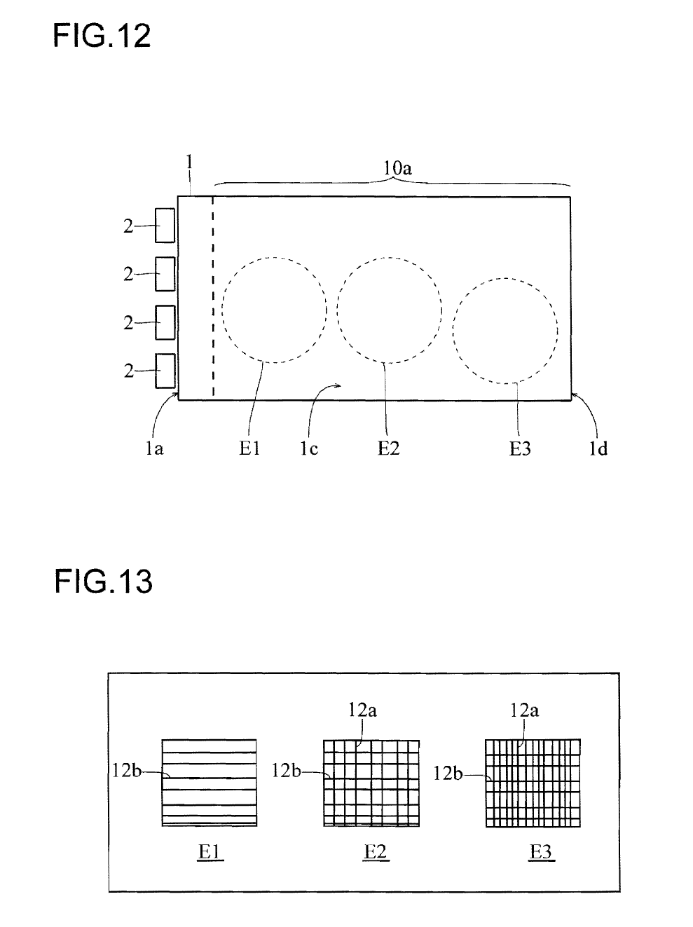

### BRIEF DESCRIPTION OF DRAWINGS

[FIG. 1] A side view of a light guide plate according to an embodiment of the present invention.

[FIG. 2] A view on an enlarged scale showing part of a light output surface of the light guide plate according to the embodiment shown in FIG. 1 (enlarged view of a region A1 enclosed with a broken line in FIG. 1).

[FIG. 3] A plan view of the light guide plate according to the embodiment shown in FIG. 1 as seen from the side of the light output surface.

[FIG. 4] A schematic view showing portions of a diffraction grating pattern, which lie respectively within regions B1 and B2 enclosed with broken lines in FIG. 3.

[FIG. 5] A view on an enlarged scale showing part of a light reflection surface of the light guide plate according to the embodiment shown in FIG. 1 (enlarged view of a region A2 enclosed with a broken line in FIG. 1).

[FIG. 6] A plan view of the light guide plate according to the embodiment shown in FIG. 1 as seen from the side of the light reflection surface.

[FIG. 7] A schematic view showing portions of a prism pattern, which lie respectively within regions C1 to C3 enclosed with broken lines in FIG. 6.

[FIG. 8] A view for explaining the behavior of light inside the light guide plate according to the embodiment shown in FIG. 1.

[FIG. 9] A view for explaining the behavior of light in a case where the prism pattern is not provided on the light reflection surface of the light guide plate.

[FIG. 10] A cross-sectional view of a backlight device using the light guide plate shown in FIG. 1.

[FIG. 11] A cross-sectional view of a liquid crystal display device in which the backlight device shown in FIG. 10 is mounted.

[FIG. 12] A plan view of a light guide plate as a modified example of the present embodiment as seen from the side of a light reflection surface.

[FIG. 13] A schematic view showing portions of a prism pattern, which lie respectively within regions E1 to E3 enclosed with broken lines in FIG. 12.

[FIG. 14] A side view of a light guide plate according to the conventional technique.

[FIG. 15] A view for explaining the behavior of light inside the light guide plate according to the conventional technique.

### LIST OF REFERENCE SYMBOLS

1 Light guide plate
1a Light incidence surface
1b Light output surface
1c Light reflection surface
2 Light source
10 Backlight device
11 Diffraction grating pattern
12 Prism pattern
20 Liquid crystal display panel

### BEST MODE FOR CARRYING OUT THE INVENTION

Referring to FIGS. 1 to 7, the description is directed first to a light guide plate 1 according to the present embodiment.

The light guide plate 1 according to the present embodiment has a configuration shown in FIG. 1 and is made of a transparent material. As the constituent material of the light guide plate 1, for example, polymethyl methacrylate (hereinafter, referred to as “PMMA”), cycloolefin, polycarbonate, and the like can be used.

Furthermore, the light guide plate 1 is formed substantially in a plate shape and has four side end surfaces and two surfaces (front and back surfaces) that are perpendicular to the four side end surfaces. A predetermined one of the four side end surfaces of the light guide plate 1 functions as a light incidence surface 1a for introducing light generated by a light source 2 into the light guide plate 1. Moreover, the front surface of the light guide plate 1 functions as a light output surface 1b for outputting light inside the light guide plate 1 in a planar shape, and the back surface of the light guide plate 1 functions as a light reflection surface 1c for reflecting light inside the light guide plate 1 toward the side of the light output surface 1b. Incidentally, these surfaces are substantially in a rectangular shape.

Furthermore, as shown in FIGS. 1 and 2, in a region of the light output surface 1b of the light guide plate 1, which corresponds to an effective light-emitting area 10a, a diffraction grating pattern 11 is formed integrally over the entire area of that region. The diffraction grating pattern 11 is a periodic concave-convex structure and is formed so as to have a grating pitch of not less than 360 nm and not more than 470 nm (preferably, 400 nm) and a grating height of not less than 160 nm and not more than 240 nm (preferably, 200 nm). In a case of obtaining a diffraction grating pattern with an aspect ratio of the order of 1:1 as the diffraction grating pattern 11, such a diffraction grating pattern can be easily formed on the light output surface 1b of the light guide plate 1 by an imprinting method or the like.

Furthermore, an optimum grating pitch d of the diffraction grating pattern 11 depends on the constituent material of the light guide plate 1 and is calculated using an equation (1) below.

d=550 nm/sin 60°×(a refractive index of the constituent material of the light guide plate) (1)

Based on this, in a case where the constituent material of the light guide plate 1 is polycarbonate (refractive index: 1.59), the optimum grating pitch d of the diffraction grating pattern 11 is determined to be 400 nm Moreover, in a case where the constituent material of the light guide plate 1 is cycloolefin (refractive index: 1.53), the optimum grating pitch d of the diffraction grating pattern 11 is determined to be 415 nm, and in a case where the constituent material of the light guide plate 1 is PMMA (refractive index: 1.49), the optimum grating pitch d of the diffraction grating pattern 11 is determined to be 430 nm. Incidentally, the optimum grating pitch d of the diffraction grating pattern 11 has a tolerance range of ±40 nm.

Meanwhile, in a case where the diffraction grating pattern 11 is formed on the light output surface lb of the light guide plate 1 at a constant density over the entire surface, resulting output light has an intensity increasing with increasing proximity to the light incidence surface la of the light guide plate 1 and decreasing with increasing distance from the light incidence surface 1a of the light guide plate 1. For this reason, in order to obtain a uniform intensity of output light over the entire surface, it is necessary that, as shown in FIGS. 3 and 4, the diffraction grating pattern 11 be formed at a density gradually increasing in a direction from the side of the light incidence surface 1a to the side of a counter-light incidence surface (surface of the light guide plate 1 on the side opposite to the light incidence surface 1a) 1d of the light guide plate 1. Thus, preferably, for example, assuming a 100 μm-square area in which the diffraction grating pattern 11 is provided all over as one unit, the units are set to be disposed at a density of the order of 40% in a region of the light guide plate 1 on the side of the light incidence surface 1a and at a density of 100% in a region of the light guide plate 1 on the side of the counter-light incidence surface 1d, and the density at which the units are disposed in a region interposed between these regions is made to vary by gradation.

Here, in the present embodiment, as shown in FIGS. 1 and 5, in a region of the light reflection surface 1c of the light guide plate 1, which corresponds to the effective light-emitting area 10a, a prism pattern 12 is formed integrally under such a condition as to maximally prevent light inside the light guide plate 1 from having an incidence angle exceeding a critical angle. The prism pattern 12 is made up of sawtooth-shaped prism grooves (groove portions) that extend in a linearly continuous manner in a direction parallel to the light incidence surface 1a of the light guide plate 1 and are formed by engraving from the light reflection surface 1c toward the side of the light output surface lb of the light guide plate 1. That is, the prism pattern 12 has an inclined surface inclined relative to the light reflection surface 1c of the light guide plate 1 and a surface perpendicular to the light reflection surface 1c of the light guide plate 1. Furthermore, the prism pattern 12 is formed so that the prism grooves have a size (a length L in FIG. 5) of not less than 10 μm and not more than 100 μm and are arranged at a pitch of not less than 30 μm and not more than 500 μm. Moreover, the prism pattern 12 is formed so that the prism grooves have an inclination angle (an angle θ in FIG. 5) of not less than 0.5° and not more than 20°.

It is to be noted that, unlike the diffraction grating pattern 11, the prism pattern 12 is not formed over the entire area of the region corresponding to the effective light-emitting area 10a. To be specific, in the region corresponding to the effective light-emitting area 10a, the prism pattern 12 is not present in a region of the light reflection surface 1c of the light guide plate 1 on the side of the light incidence surface 1a and is present only in a region of the light reflection surface 1c of the light guide plate 1 other than the region on the side of the light incidence surface 1a. In other words, in a region corresponding to the effective light-emitting area 10a, the region in which the prism pattern 12 is formed is smaller than the region in which the diffraction grating pattern 11 is formed, and the region of the light reflection surface 1c of the light guide plate 1 on the side of the light incidence surface la forms a flat portion (see a region C1 in FIGS. 6 and 7). Moreover, the prism pattern 12 is formed so that, in the region corresponding to the effective light-emitting area 10a, the prism grooves are arranged at a pitch gradually decreasing in the direction from the side of the light incidence surface 1a to the side of the counter-light incidence surface 1d of the light guide plate 1 (see regions C2 and C3 in FIGS. 6 and 7).

For example, when the prism pattern 12 is set to have a prism angle of 2° and a prism pitch gradually decreasing from 500 μm to 55 μm in the direction from the side of the light incidence surface 1a to the side of the counter-light incidence surface 1d of the light guide plate 1, and the flat portion present in the region of the light reflection surface 1c of the light guide plate 1 on the side of the light incidence surface 1a is set to have a length of the order of 6 mm (in a case where the light guide plate 1 is 0.6 mm in thickness), the intensity of output light can be made uniform over the entire surface. Incidentally, the prism angle of the prism pattern 12 may be constant but does not have to be constant as long as it falls within such a range as to prevent light inside the light guide plate 1 from having an incidence angle exceeding a critical angle.

Referring to FIG. 8, the description is directed next to the behavior of light inside the light guide plate 1 according to the present embodiment.

In this embodiment, as shown in FIG. 8, when light generated by the light source 2 is introduced through the light incidence surface 1a of the light guide plate 1, in a region in which the diffraction grating pattern 11 and the prism pattern 12 are not present, the light is reflected totally in a repeated manner while traveling through that region and thus travels from the side of the light incidence surface 1a toward the side of the counter-light incidence surface 1d of the light guide plate 1. Furthermore, light traveling in a direction that forms a small angle with the normal to the diffraction grating pattern 11 is outputted to the outside of the light guide plate 1 via the diffraction grating pattern 11. Light distribution characteristics obtained at this time in the region of the light guide plate 1 on the side of the light incidence surface 1a are as indicated by an arrow D1.

In this case, if the prism pattern 12 is not provided on the light reflection surface 1c of the light guide plate 1, as shown in FIG. 9, light distribution characteristics increase in sharpness in the direction from the side of the light incidence surface 1a to the side of the counter-light incidence surface 1d of the light guide plate 1. That is, the incidence angle of light incident on the diffraction grating pattern 11 varies between in the region of the light guide plate 1 on the side of the light incidence surface 1a and in the region of the light guide plate 1 on the side of the counter-light incidence surface 1d, so that the output angle of light outputted from the diffraction grating pattern 11 varies between in the region of the light guide plate 1 on the side of the light incidence surface 1a and in the region of the light guide plate 1 on the side of the counter-light incidence surface 1d.

In contrast, in the present embodiment, as shown in FIG. 8, light reflection by the prism pattern 12 does not occur in the region of the light guide plate 1 on the side of the light incidence surface 1a, whereas it occurs in a region of the light guide plate 1 other than the region on the side of the light incidence surface 1a. Because of this, the angle at which light travels increases in steepness gradually in the direction from the side of the light incidence surface 1a toward the side of the counter-light incidence surface 1d of the light guide plate 1, so that, in that direction, the amount of light traveling in a direction that forms a small angle with the normal to the diffraction grating pattern 11 increases accordingly. As a result, in the region of the light guide plate 1 on the side of the counter-light incidence surface 1d, light distribution characteristics as indicated by an arrow D2 are obtained. That is, light distribution characteristics obtained in the region of the light guide plate 1 on the side of the light incidence surface 1a are made substantially the same as those obtained in the region of the light guide plate 1 on the side of the counter-light incidence surface 1d. Thus, the incidence angle of light incident on the diffraction grating pattern 11 is made substantially the same between in the region of the light guide plate 1 on the side of the light incidence surface 1a and in the region of the light guide plate 1 on the side of the counter-light incidence surface 1d, so that the output angle of light outputted from the diffraction grating pattern 11 is made substantially the same between in the region of the light guide plate 1 on the side of the light incidence surface 1a and in the region of the light guide plate 1 on the side of the counter-light incidence surface 1d.

Referring to FIG. 10, the description is directed next to the configuration of a backlight device 10 using the light guide plate 1 shown in FIG. 1.

The backlight device 10 is of the edge-lit type and includes at least the light guide plate 1 shown in FIG. 1, a light source 2, and a reflection sheet 3. The light guide plate 1, the light source 2, and the reflection sheet 3 are supported by a frame 4 made of polycarbonate or the like.

The light source 2 is formed of a light-emitting diode element (LED) and is disposed so that a light-emitting surface thereof is opposed to the light incidence surface 1a of the light guide plate 1. Incidentally, a flexible printed circuit board (FPC) 5 is connected to the light source 2. The reflection sheet 3 is made of polyethylene terephthalate (PET) or the like and is disposed on the side of the light reflection surface 1c of the light guide plate 1.

Referring to FIG. 11, the description is directed next to the configuration of a liquid crystal display device in which the backlight device 10 shown in FIG. 10 is mounted.

This liquid crystal display device includes at least the backlight device 10 shown in FIG. 10, and a liquid crystal display panel 20. The liquid crystal display device is so configured that the liquid crystal display panel 20 is illuminated by the backlight device 10, and thus an image is displayed on a display surface of the liquid crystal display panel 20.

The liquid crystal display panel 20 is composed of a pair of substrates 21 and 22 sandwiching a liquid crystal layer (not shown) therebetween, a polarization plate 23, and the like. The substrate 21 as one of the pair of substrates 21 and 22 is a substrate on which a thin-film transistor (TFT) and the like are provided, and the substrate 22 as the other of the pair of substrates 21 and 22 is a substrate on which a color filter and the like are provided. The polarization plate 23 is disposed on each of the respective surfaces of the substrates 21 and 22 on the sides opposite to the liquid crystal layer side. Incidentally, a FPC 24 is connected to the substrate 22 as the other of the pair of substrates 21 and 22.

The liquid crystal display panel 20 is obtained by, for example, laminating the pair of substrates 21 and 22 to each other so that the liquid crystal layer (not shown) is sandwiched therebetween, subjecting a laminate thus obtained to etching using a fluorine-based chemical solution so that the thickness thereof is reduced, and subsequently laminating the polarization plate 23 onto each of the respective surfaces of the substrates 21 and 22 on the sides opposite to the liquid crystal layer side. Then, the backlight device 10 is laminated to the periphery of the liquid crystal display panel 20, and thus the liquid crystal display device is completed.

In the present embodiment, with the above-described configuration, the output angle of light outputted from the diffraction grating pattern 11 is made substantially the same between in the region of the light guide plate 1 on the side of the light incidence surface 1a and in the region of the light guide plate 1 on the side of the counter-light incidence surface 1d, and thus the uniformity of output light over the entire surface can be achieved, thereby allowing the occurrence of glare to be suppressed. Furthermore, light is outputted efficiently from the diffraction grating pattern 11, thereby also allowing improved light utilization efficiency to be obtained. Moreover, in the backlight device 10 using the light guide plate 1 according to the present embodiment, there is no need to dispose optical sheets on the light output surface 1b of the light guide plate 1, and thus the thickness reduction of the device can be easily achieved.

Furthermore, in the present embodiment, as described above, the prism angle of the prism pattern 12 is set to not less than 0.5° and not more than 20°, and thus, in the region of the light guide plate 1 other than the region on the side of the light incidence surface 1a, the angle at which light travels can be easily increased in steepness gradually in the direction from the side of the light incidence surface 1a to the side of the counter-light incidence surface 1d of the light guide plate 1.

Furthermore, in the present embodiment, as described above, the grating pitch of the diffraction grating pattern 11 is set to not less than 360 nm and not more than 470 nm and the grating height thereof is set to not less than 160 nm and not more than 240 nm, and thus high diffraction efficiency can be obtained with respect to light of a plurality of different wavelengths.

The embodiment disclosed in this application is to be considered in all respects as illustrative and not limiting. The scope of the present invention is indicated by the appended claims rather than by the foregoing description of the embodiment, and all changes that come within the meaning and range of equivalency of the claims are intended to be embraced therein.

For example, in the above-described embodiment, the prism grooves extending continuously in the direction parallel to the light incidence surface of the light guide plate are formed on the light reflection surface of the light guide plate. The present invention, however, is not limited thereto, and a configuration is also possible in which a predetermined number of prism grooves are arranged in the direction parallel to the light incidence surface of the light guide plate so as to interpose the flat portion in between. In this case, it is possible that, with the prism width in the direction parallel to the light incidence surface of the light guide plate set to be constant, the prism pitch is decreased gradually in the direction from the side of the light incidence surface to the side of the counter-light incidence surface of the light guide plate. It is also possible that, with the prism pitch in the direction from the side of the light incidence surface toward the side of the counter-light incidence surface of the light guide plate set to be constant, the prism width in the direction parallel to the light incidence surface of the light guide plate is increased gradually in the direction from the side of the light incidence surface to the side of the counter-light incidence surface of the light guide plate. It is further possible that, with the prism pitch and the prism width set to be constant, the prism angle is increased gradually in the direction from the side of the light incidence surface to the side of the counter-light incidence surface of the light guide plate.

Furthermore, in the above-described embodiment, only the prism grooves extending in the direction parallel to the light incidence surface of the light guide plate are formed on the light reflection surface of the light guide plate. The present invention, however, is not limited thereto, and it is also possible that, as shown in FIGS. 12 and 13, prism grooves 12a extending in the direction parallel to the light incidence surface 1a of the light guide plate 1 and prism grooves 12b extending in a direction perpendicular to the light incidence surface 1a of the light guide plate 1 are formed on the light reflection surface 1c of the light guide plate 1.

1. A light guide plate, comprising:
a light incidence surface for introducing light therethrough;
a light output surface for outputting, in a planar shape, light introduced through the light incidence surface; and
a light reflection surface, which is a surface on a side opposite to the light output surface, for reflecting light introduced through the light incidence surface toward a side of the light output surface,
wherein
a diffraction grating pattern is formed on the light output surface, and a prism pattern is formed on the light reflection surface, and
the prism pattern is not present in a region of the light reflection surface on a side of the light incidence surface, so that a region in which the prism pattern is formed is smaller than a region in which the diffraction grating pattern is formed.

2. The light guide plate according to claim 1, wherein
the prism pattern is made up of groove portions extending in a direction parallel to the light incidence surface and is formed so as to have a surface inclined at an angle of not less than 0.5° and not more than 20° relative to the light reflection surface.

3. The light guide plate according to claim 1, wherein
the diffraction grating pattern is formed so as to have a grating pitch of not less than 360 nm and not more than 470 nm and a grating height of not less than 160 nm and not more than 240 nm.

4. A backlight device, comprising:
the light guide plate according to claim 1; and
a light source for generating light to be introduced to the light guide plate.

5. A liquid crystal display device, comprising:
the backlight device according to claim 4; and
a liquid crystal display panel that is illuminated by the backlight device.

6. A backlight device, comprising:
the light guide plate according to claim 2; and
a light source for generating light to be introduced to the light guide plate.

7. A backlight device, comprising:
the light guide plate according to claim 6; and
a light source for generating light to be introduced to the light guide plate.

8. A liquid crystal display device, comprising:
the backlight device according to claim 3; and
a liquid crystal display panel that is illuminated by the backlight device.

9. A liquid crystal display device, comprising:
the backlight device according to claim 8; and
a liquid crystal display panel that is illuminated by the backlight device.
